(19) United States
(12) Patent Application Publication
(10) Pub. No.: US 2011/0232239 A1
(43) Pub. Date: Sep. 29, 2011

(54) DEVICE FOR TRANSPORTING OBJECTS

(75) Inventors: Dieter Winter, Bayreuth (DE); Klaus Rothermel, Unteregg (DE)

(73) Assignee: MULTIVAC SEPP HAGGENMULLER GMBH & CO. KG, Wolfertschwenden (DE)

(21) Appl. No.: 13/069,010

(22) Filed: Mar. 22, 2011

(30) Foreign Application Priority Data
Mar. 24, 2010 (DE) 10 2010 012 597.0

(51) Int. Cl. B65B 11/52; F26B 25/06; B65B 31/00; B65G 15/14; B65G 43/00

(52) U.S. Cl. 53/509; 34/236; 53/510; 198/339.1; 198/341.01

(57) ABSTRACT

A device for conveying objects includes a conveyor belt for the transport of the objects and fluid nozzles for the treatment of the objects. The device is characterised in that in addition to the conveyor belt a second belt is provided which is arranged above the conveyor belt in order to retain an object on the conveyor belt. This transport device can be installed in a packaging system, in particular in a tunnel dryer or in a shrink tunnel for packages.

### CROSS-REFERENCE TO RELATED APPLICATIONS

This application claims foreign priority benefits under 35 U.S.C. §119(a)-(d) to German patent application number DE 102010012597.0, filed Mar. 24, 2010, which is hereby incorporated by reference in its entirety.

### TECHNICAL FIELD

The present disclosure relates to a device for transporting objects with a conveyor belt, as well as to a tunnel dryer and shrink tunnel including such a device, and to a packaging system including such a tunnel dryer and/or shrink tunnel.

### BACKGROUND

In packaging machines on which packages in substantially shrinkable film are manufactured, after the process of singling out, the packages are normally transported out of the packaging machine on a conveyor belt and then passed through a so-called shrink tunnel. In this shrink tunnel the packages are passed through a hot-water bath or have hot water sprinkled or poured over them from above. Due to this transfer of heat the film shrinks and, among other things, is drawn even closer to the product and a visually very attractive package is produced. Then the packages are dried to place them into containers in further stages or to be made available dried for further process stages.

The drying normally takes place in so-called tunnel dryers. Here, the packages which come out of the shrink tunnel are transferred to a conveyor belt of the tunnel dryer into which they are conveyed. Advantageously, in the tunnel air nozzles are arranged above and below the conveyor belt, which blow off the wetness and moisture from the surface of the package with high-speed air. The conveyor belt is here formed as a grid or mesh in order to allow the air to access the package from below and also to allow the wet fluid to flow off downwards.

In order to achieve highly efficient drying with simultaneous reduction of the drying line and thus a reduced space requirement for the tunnel dryer, the amount and the speed of the air are maximised. This leads to the problem that, due to the air flow, light or geometrically unfavourable packages can change their position on the conveyor belt or even be lifted up. This can lead to damage to the packages or to a backlog at the end of the drying section in the tunnel dryer.

In the further course of the process the whole packaging line may be brought to a standstill and the productivity may be negatively affected.

### SUMMARY

An object of the present disclosure is to make a device available and a tunnel dryer and/or a shrink tunnel with which the disadvantages described above can be remedied.

In order to prevent light objects (e.g. packages) or objects with an unfavourable surface design from being blown sidewards or upwards by the lower fluid nozzles (e.g. water or air nozzles) and thus being tilted or raised or not being able to be transported through a nozzle curtain, a device according to the present disclosure is used in which, by means of a second belt that runs parallel above the conveyor belt, the packages are held down on the conveyor belt by the placement of the second belt.

In this way it is ensured that the packages do not change their position on the conveyor belt and are thus transported reliably, e.g. through a shrink dryer or tunnel dryer, despite the highest power of fluid flow and the nozzles fitted on both or on all sides.

Here it is of advantage if the conveyor belt and the second upper belt move synchronously at the same speed in order not to change the position of the package or the position of a plurality of packages on, and with respect to, the conveyor belt.

In order to achieve a synchronous speed between both belts, it is necessary that either both belts have their own drive or that they have a common drive with which, for example, a drive shaft of the second belt is driven by gears or belts from a drive shaft of the conveyor belt.

Since in a tunnel dryer the efficiency of drying also depends on high air and water permeability of both belts so that an air flow is provided along the package and also the drainage of wet fluid and moisture is ensured in order to be able to transport a package out of the tunnel dryer sufficiently dried for a following process using a drying section as short as possible, preferably openings in a second belt are provided, simultaneously with a type of grid structure.

The second belt according to the present disclosure may be implemented in an advantageous manner as a metal-mesh belt which has an open-mesh area of 70% or preferably 80%.

It has been found to be practicable and particularly effective if both belts, the conveyor belt and the second belt, are implemented in the same material, preferably as a metal-mesh belt.

One of the belts or both belts can have crossbars to prevent the belt sagging transversely to the transport direction.

If the material of the second belt is selected suitably, the packages are securely held by the force of the weight of the freely suspended belt on the conveyor belt. In this respect the second belt can be placed on the package such that the package is not just contacted on the upper side or at a highest point, but rather, viewed from the front and rear in the transport direction, it is placed on the package without exerting any damaging pressure on the package.

In order that with certain embodiments of the belt material no undesired snagging of the belts occurs when the belts move in the tunnel dryer without packages, a support strip is provided at least on one side of the conveyor belt which prevents this and also acts as a side delimitation of the conveying surface of the conveyor belt. Advantageously, support strips are provided on both sides, which are implemented such that it is ensured that despite a given sagging of the second belt, no contact with the conveyor belt is possible when the second belt is placed on the support strips at the sides. A preferred material for the support strip is polyoxymethylene (POM).

In order to ensure that the packages are securely held on the conveyor belt already before they reach the treatment section, here a drying section (this is defined as the region in which air flows or turbulences due to various fluid nozzles, here air nozzles, act from above and below and/or on all sides), the second belt protrudes beyond the drying section at least at the entry end.

With different package sizes and heights it has proven to be particularly advantageous if the device according to the present disclosure is implemented adjustable in height to prevent the packages from being stressed differently.

Since a front and rear guide shaft of the second belt may also limit the maximum product height, here it is also practicable to adapt to the height of the package by means of height adjustment of the shafts. As a secondary effect, this has the advantage that also the upper air nozzles can be implemented with the device adjustable in height in order to ensure the maximum efficiency of the air flow for drying.

For an automatically running process in a packaging system preferably a sensor in the region of the package guidance system to the tunnel dryer is provided for determining the package height, which is connected in an advantageous manner to a controller which carries out the adjustment of the device according to the invention in dependence of the package height.

This device is particularly suitable for use in a tunnel dryer for drying packages which have previously passed through a shrink tunnel with hot water for shrinking suitable films, so that wet fluid, drops or moisture is/are located on and at the package.

Also the use of this device in a shrink tunnel for treating packages with hot water is possible here to be able to transport light packages securely through the fluid spray.

A packaging system according to the present disclosure comprises a packaging machine which produces packages with the product content, which are then conveyed through a shrink tunnel for shrinking the packages and then passed to a tunnel dryer with the device according to the present disclosure.

In the following an advantageous embodiment of the present disclosure is presented in more detail based on the below drawings.

### BRIEF DESCRIPTION OF THE DRAWINGS

FIG. 1 is a perspective view of a tunnel dryer according to the present disclosure;

FIG. 2 shows the state of the art in the drying region of a tunnel dryer; and

FIG. 3 shows an embodiment of a device according to the present disclosure.

### DETAILED DESCRIPTION

In the figures identical components are designated with the same reference numerals throughout.

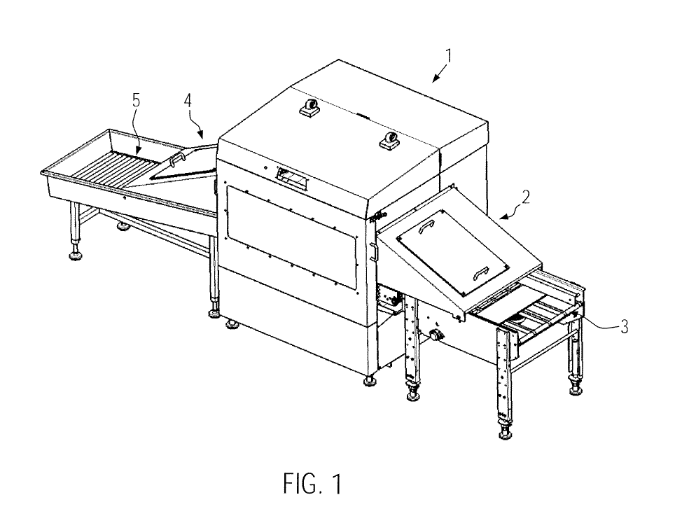

FIG. 1 shows a tunnel dryer 1 with a feed end 2 and a feed belt 3 as well as an output end 4 and a roller conveyor 5 on which dry packages are conveyed out of the tunnel dryer.

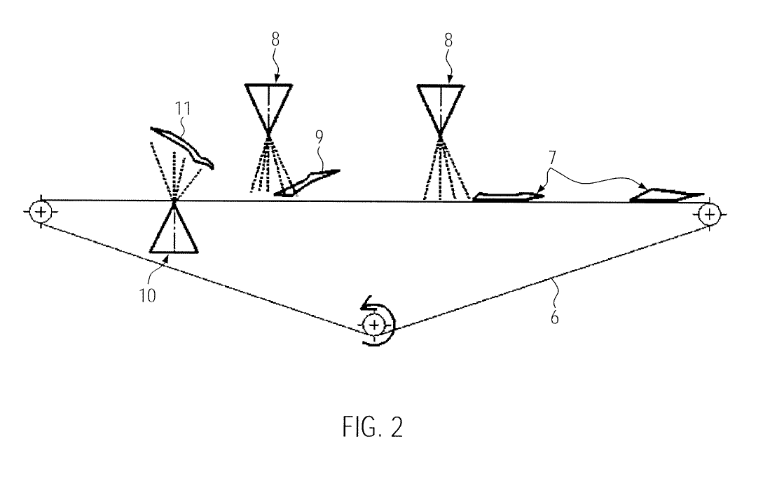

FIG. 2 represents the state of the art and illustrates the inside of a tunnel dryer schematically as a side elevation with a conveyor belt 6 and packages 7 located on it. There are air nozzles 8 which blow air onto the packages from above. Here, there is the risk that packages 9 can be forced back by the air flow, because air speeds of 100 m/s and above can be attained and the conveyor belt 6 is not able to transport this package 9 past all air nozzles.

Due to air nozzles 10 which are arranged underneath the conveyor belt 6 and blow upwards onto the package 11, here unwanted lifting of a light package 11 may occur as shown in FIG. 2. This may lead to problems, such as damage to the package, a backlog of packages in the tunnel dryer or other process faults.

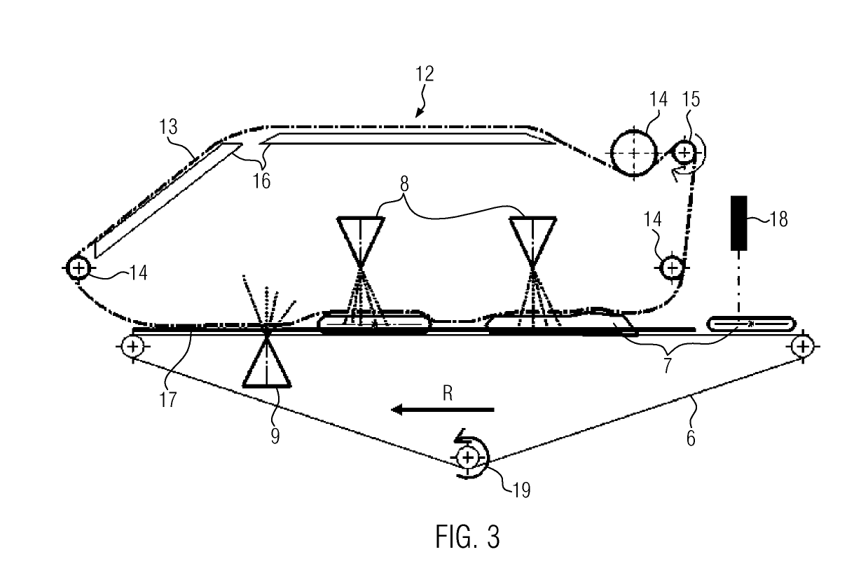

FIG. 3 shows the side elevation of a device 12 according to the present disclosure which is located inside a tunnel dryer 1. The conveyor belt 6 is implemented as in the state of the art. The packages 7 are fed to the tunnel dryer by means of the conveyor belt 6 already before the region of the drying section. The transport direction R is specified with an arrow pointing to the left. A second belt 13 is passed over shafts 14 and 15 as well as guides 16, whereby the shaft 15 is implemented driven. The second conveyor belt 13 runs synchronously with the conveyor belt 6 and is arranged above the conveyor belt 6.

The second belt 13 is (referred to the path defined by all the shafts and deflection rollers) implemented with an excess length of 2% to 10%, which enables it to sag between the lower deflection rollers and thereby to compensate the height differences of the packages 7 and also to be positioned on and/or partly around the package 7, so that on one hand the package 7 is held down against the conveyor belt 6 and on the other hand, due to the adhesion occurring, the package 7 is itself conveyed further synchronously with the conveyor belt 6.

The risk of a package backlog due to being forced back or the lifting of packages is thereby eliminated.

The side support strips 17 are present in the region in which there is the risk or possibility that the second belt 13 could come into contact with the conveyor belt 6.

The device 12 with the second belt 13 is adjustable in height in the range X, i.e. the vertical distance X between the conveyor belt 6 and the lower edge of the shafts 14 can be changed.

A sensor 18 in the transport direction R in front of the device 12 can measure the product heights and quantity and pass them to the controller, which is not illustrated and which controls the adjusted height X advantageously for the process of drying and transport in dependence of the packages 7 located in the drying section.

As an alternative to a dedicated drive of the shaft 15 of the second belt 13 it is practicable to couple the shaft 15 with a drive shaft 19 of the conveyor belt 6 also in order to achieve synchronisation of both belts 6, 13 with respect to one another in the most simple manner.

The air nozzles 8 can have a fixed distance to the conveyor belt 6, they can be adjusted with the second belt 13 in relation to the height X or have a dedicated method of adjustment.

The operational procedure can be described as follows:

A package 7 is transferred to the tunnel dryer 1 and is conveyed by means of the conveyor belt 6 in the region of the device 12. Due to the weight of the second belt 13, implemented as the upper retaining belt, the package 7 is pressed onto the conveyor belt 6, because the second belt 13 sags due to its force of weight and the corresponding (excess) length of the freely suspended belt. The upper retaining belt 13 adapts itself to the shape of the package, lies on the package 7 and moves with the package 7. Thus, the package 7 cannot be displaced, lifted or turned over by air currents. Within a certain range, the product height can vary without adjustment work or setting of the device being required. The maximum package height X is determined by the shafts 14 on the entry and exit of the device 12 and possibly by the position of the upper nozzles 8. At the end of the device 12 the upper retaining belt 13 lifts off from the package 7 and releases it for further transport out of the tunnel dryer 1.

It is also conceivable to use the device 12 embodied in the present disclosure for retaining packages 7 on a conveyor belt in a shrink tunnel in order to transport packages 7 reliably through a hot-water curtain or through a hot-water bath. In this case water is used as the fluid medium.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A device for transporting objects, the device comprising:
a conveyor belt for transporting the objects;
multiple fluid nozzles for treatment of the objects during transport on the conveyor belt; and
a second belt arranged above the conveyor belt and configured to retain the objects during transport on the conveyor belt.

2. The device according to claim 1, wherein the second belt is movable at the same speed as the conveyor belt.

3. The device according to claim 1, further comprising a drive for driving the second belt.

4. The device according to claim 1, further comprising a common drive for driving the conveyor belt and the second belt.

5. The device according to claim 1, wherein the second belt comprises a grid structure including multiple openings.

6. The device according to claim 1, wherein the second belt comprises a metal-mesh belt.

7. The device according to claim 1, wherein the second belt has an open mesh area of over 70%.

8. The device according to claim 1, wherein the conveyor belt and the second belt comprise the same material.

9. The device according to claim 1, wherein gravitational force acting on the second belt causes the second belt to retain the objects on the conveyor belt.

10. The device according to claim 1, further comprising a support strip, on which the second belt can be supported, disposed at a side of the device.

11. The device according to claim 1, wherein a distance over which the objects are retained by the second belt is longer than a treatment section in which the objects are treated with the fluid nozzles.

12. The device according to claim 1, wherein the fluid nozzles comprise air nozzles and/or water nozzles.

13. The device according to claim 1, wherein the second belt is adjustable to vary distance of the second belt to the conveyor belt.

14. The device according to claim 1, wherein the fluid nozzles comprise upper and/or side fluid nozzles which are adjustable to vary distance of the upper and/or side fluid nozzles to the conveyor belt.

15. The device according to claim 1, further comprising at least one sensor for acquiring a height of one of the objects.

16. The device according to claim 15, further comprising a controller in communication with the sensor, wherein the controller is configured to adjust height of the second belt based on information from the sensor.

17. A tunnel dryer comprising a device according to claim 1.

18. A shrink tunnel comprising a device according to claim 1.

19. A packaging system comprising a packaging machine for producing packages, and a shrink tunnel according to claim 18 for shrinking the packages.

20. A packaging system comprising a packaging machine for producing packages, and a tunnel dryer according to claim 17 for drying the packages.
